(19) United States
(12) Patent Application Publication
(10) Pub. No.: US 2020/0205221 A1
(43) Pub. Date: Jun. 25, 2020

(54) DATA TRANSMISSION METHOD AND APPARATUS

(71) Applicant: HUAWEI TECHNOLOGIES CO., LTD., Shenzhen (CN)

(72) Inventors: Dong LI, Shanghai (CN); Yan WANG, Shanghai (CN)

(21) Appl. No.: 16/804,930

(22) Filed: Feb. 28, 2020

Related U.S. Application Data
(63) Continuation of application No. PCT/CN2018/097734, filed on Jul. 30, 2018.

(30) Foreign Application Priority Data
Aug. 31, 2017 (CN) 201710777730.6

(51) Int. Cl. H04W 76/40; H04W 4/06; H04W 28/06; H04W 76/12

(52) U.S. Cl. CPC H04W 76/40; H04W 4/06; H04W 84/12; H04W 76/12; H04W 28/06

(57) ABSTRACT

A method includes: receiving, by a multicast service management network element, a request message from a control plane network element, where the request message carries information about a first local area network; allocating a first multicast transmission path corresponding to the first local area network, where the first multicast transmission path is used to transmit multicast data of the first local area network; sends information about the first multicast transmission path to the control plane network element; receiving first multicast data from a user plane network element, and determining that the first multicast data is the multicast data of the first local area network; and broadcasts the first multicast data to an access network device in the first local area network through the first multicast transmission path.

### CROSS-REFERENCE TO RELATED APPLICATIONS

This application is a continuation of International Application No. PCT/CN2018/097734, filed on Jul. 30, 2018, which claims priority to Chinese Patent Application No. 201710777730.6, filed on Aug. 31, 2017. The disclosures of the aforementioned applications are hereby incorporated by reference in their entireties.

### TECHNICAL FIELD

This application relates to the field of communications technologies, and in particular, to a data transmission method and an apparatus.

### BACKGROUND

The fifth generation (5G) communications technology supports an enhanced mobile broadband (eMBB) service, an ultra-reliable low latency machine type communications (uMTC) service, and the like. Most uMTC services are local and independent of the Internet. To meet an ultra-reliable low latency requirement and a data exchange requirement in a plurality of traffic modes, a local switching network is required for the uMTC service.

Based on a flexible architecture of a mobile operator, the mobile operator may create a local switching network to support the uMTC service, and different local switching networks are isolated from each other and support a multicast and/or broadcast function. The local switching network may be a local area network (LAN), and the following uses the LAN as an example for description. In the prior art, multicast packets of terminal devices in a same LAN are forwarded in the LAN by using a gateway of the LAN. Each terminal device in the LAN has an independent transmission path to the gateway of the LAN. After receiving multicast data sent by a source terminal device, the gateway replicates and encapsulates the multicast data of the source terminal device in a downlink bearer (a transmission path between the gateway and a destination terminal device) of the destination terminal device in a LAN to which the source terminal device belongs, to send the multicast data of the source terminal device to the destination terminal device in the LAN.

Conventionally, each destination terminal device in a same LAN has an independent transmission path to a gateway of the LAN. Therefore, if the LAN to which the source terminal device belongs includes a comparatively large quantity of destination terminal devices, the gateway needs to replicate the multicast data of the source terminal device for a plurality of times, and encapsulate the multicast data in a downlink bearer of each destination terminal device. A quantity of times for replicating and encapsulating the multicast data of the source terminal device is the same as a quantity of destination terminal devices. Consequently, air interface signaling overheads for sending the multicast data are high, and utilization of air interface resources is low.

### SUMMARY

Embodiments of this application provide a data transmission method and an apparatus, to reduce air interface signaling overheads for multicast data transmission in a local area network, and improve utilization of air interface resources.

According to a first aspect, a data transmission method is provided and is applied to a multicast service management network element side. The method includes the following steps: A multicast service management network element receives a request message from a control plane network element, where the request message carries information about a first local area network, and the request message is used to request the multicast service management network element to allocate a dedicated multicast transmission path to the first local area network. The multicast service management network element allocates a first multicast transmission path corresponding to the first local area network. Herein, the first multicast transmission path may be understood as a dedicated multicast transmission path of the first local area network, and the first multicast transmission path is used to transmit multicast data of the first local area network. The multicast service management network element sends information about the first multicast transmission path to the control plane network element. The information about the first multicast transmission path includes information about a local area network (or referred to as a dedicated local area network of the first multicast transmission path, namely, the first local area network) associated with the first multicast transmission path and an identifier of the first multicast transmission path. Optionally, the information about the first multicast transmission path may further include a use period of the first multicast transmission path. The identifier of the multicast transmission path may include a temporary mobile group identity (TMGI). The multicast service management network element receives first multicast data from a user plane network element, and determines that the first multicast data is the multicast data of the first local area network. Herein, the multicast data of the first local area network may be multicast and/or broadcast data sent by any terminal device (for example, a first terminal device) in the first local area network, and the terminal device may be understood as a source terminal device that sends the multicast and/or broadcast data. The multicast service management network element broadcasts the first multicast data to an access network device in the first local area network through the first multicast transmission path, to broadcast the first multicast data to a terminal device in the first local area network by using the access network device.

The multicast transmission path described in this embodiment of this application may include a multicast bearer (for example, an MBMS bearer) and/or a multicast session (an MBMS session). The multicast data provided in this embodiment of this application may include multicast data and/or broadcast data, for example, MBMS service data.

In this embodiment of this application, the multicast service management network element may broadcast the multicast data of the source terminal device in the first local area network to the access network device in the first local area network, and other terminal devices (for example, a terminal device other than the source terminal device 1) in the first local area network may separately receive the multicast data from access network devices connected to the other terminal devices. The multicast service management network element does not need to add the multicast data of the source terminal device to a downlink bearer of each terminal device in the local area network. This can reduce air interface signaling overheads for data exchange of terminal devices in the first local area network, and improve utilization of air interface resources, and applicability is higher.

In a possible implementation, the multicast service management network element may receive the first multicast data from the user plane network element through an uplink data tunnel corresponding to the first local area network, and the multicast service management network element determines, based on an identifier of the uplink data tunnel, that the first multicast data is the multicast data of the first local area network. The multicast service management network element determines, by matching the identifier of the uplink data tunnel for receiving the first multicast data and an identifier of an uplink data tunnel allocated to the first local area network, that the received first multicast data is from the first local area network. This can improve efficiency of determining a local area network to which the first multicast data belongs, and further improve multicast data transmission efficiency.

In a possible implementation, the request message received by the multicast service management network element from the control plane network element may carry an identifier of the first local area network, the multicast service management network element may allocate the uplink data tunnel corresponding to the first local area network, and send the identifier of the uplink data tunnel corresponding to the first local area network to the control plane network element, and then the control plane network element may send a correspondence between the identifier of the first local area network and the identifier of the uplink data tunnel to the user plane network element. Herein, the uplink data tunnel is an uplink data tunnel from the user plane network element to the multicast service management network element, and the uplink data tunnel corresponding to the first local area network is used to transmit the multicast data of the first local area network. For example, when needing to send the multicast data of the first local area network to the multicast service management network element, the user plane network element may transmit the multicast data through the uplink data tunnel corresponding to the first local area network. The multicast service management network element can quickly determine, based through the uplink data tunnel for transmitting the multicast data, that the multicast data is from the first local area network. This improves efficiency of determining a source of the multicast data.

In a possible implementation, before sending the request message to the multicast service management network element, the control plane network element may send a connection request message to the multicast service management network element. The connection request message may also be used to request to allocate a dedicated uplink data tunnel to the first local area network. The multicast service management network element receives the connection request message from the control plane network element, and the connection request message carries an identifier of the first local area network. The multicast service management network element allocates the uplink data tunnel corresponding to the first local area network, and sends the identifier of the uplink data tunnel corresponding to the first local area network to the control plane network element, so that the uplink data tunnel corresponding to the first local area network is allocated in diverse manners, operations are more flexible, and applicability is higher.

In a possible implementation, the information about the first local area network provided in this embodiment of this application includes the identifier (for example, an ID of the first local area network) of the first local area network and information about a cell covered by the first local area network, and the cell covered by the first local area network includes a first cell in which the source terminal device (also referred to as the first terminal device) sending the multicast data is located. The information about the first local area network may be used to determine a coverage area of the first multicast transmission path corresponding to the first local area network, and the first multicast transmission path may be used to broadcast the multicast data of the first local area network to an access network device in the cell covered by the first local area network.

In a possible implementation, after the first terminal device in the first local area network is handed over from an attached cell, the multicast service management network element may receive an update request from the control plane network element. The update request includes information about a second cell to which the first terminal device moves and the information about the first local area network, the information about the first local area network herein includes the information about the cell covered by the first local area network, and the cell covered by the first local area network includes the first cell in which the first terminal device is located before moving. The multicast service management network element updates, based on the information about the second cell and the information about the first local area network, information about a cell covered by the first multicast transmission path. Updated information about the cell covered by the first multicast transmission path includes the information about the second cell. After updating the information about the cell covered by the first multicast transmission path, the multicast service management network element may broadcast the multicast data of the first local area network to an access network device in the second cell through the first multicast transmission path. Herein, the access network device in the second cell includes an access network device connected to the first terminal device. Therefore, the first terminal device can receive the multicast data of the first local area network by using the access network device connected to the first terminal device. According to this embodiment of this application, continuity of obtaining the multicast data of the first local area network by the terminal device in the first local area network 1 can be ensured, data transmission reliability of the dedicated multicast transmission path of the first local area network is improved, and applicability is higher.

According to a second aspect, a data transmission method is provided and is applied to a control plane network element side. The method includes the following steps. A control plane network element sends a request message to a multicast service management network element, where the request message carries information about a first local area network, and the request message is used to request to allocate a first multicast transmission path corresponding to the first local area network. The control plane network element receives information about the first multicast transmission path from the multicast service management network element. The control plane network element sends the information about the first multicast transmission path to an access network device in the first local area network. Herein, for the information about the first multicast transmission path, refer to related content in the first aspect. Details are not described herein again. The control plane network element sends the information about the first multicast transmission path to the access network device, to notify that the first multicast transmission path is a dedicated multicast transmission path of the first local area network and is used to broadcast multicast data of the first local area network. After obtaining the information about the first multicast transmission path, the access network device can listen to, on the first multicast transmission path, the multicast data of the first local area network broadcast by the multicast service management network element. In this application, signaling overheads consumed for transmitting the multicast data of the first local area network can be reduced, and resource utilization of the multicast transmission path of the first local area network can also be improved.

In a possible implementation, after a first terminal device in the first local area network moves, the control plane network element may obtain information about a second cell to which the first terminal device moves, and send an update request to the multicast service management network element. The update request includes the information about the second cell and the information about the first local area network. Herein, the update request is used to trigger the multicast service management network element to update information about a cell covered by the dedicated first multicast transmission path of the first local area network, to add a new cell in which the first terminal device is located to a cell set covered by the first multicast transmission path, so that multicast data broadcast through the dedicated first multicast transmission path of the first local area network can arrive at the cell in which the first terminal device is located. According to this embodiment of this application, continuity of obtaining the multicast data of the first local area network by the terminal device in the first local area network 1 can be ensured, data transmission reliability of the dedicated multicast transmission path of the first local area network is improved, and applicability is higher.

In a possible implementation, the control plane network element sends a connection request message to the multicast service management network element. The connection request message carries an identifier of the first local area network, and the connection request message is used to request to allocate an uplink data tunnel corresponding to the first local area network, and the uplink data tunnel is an uplink data tunnel from a user plane network element to the multicast service management network element. The control plane network element receives an identifier of the uplink data tunnel corresponding to the first local area network from the multicast service management network element, and sends a correspondence between the identifier of the first local area network and the identifier of the uplink data tunnel to the user plane.

According to a third aspect, a data transmission method is provided and is applied to a user plane network element side. The method includes the following steps. A user plane network element receives a correspondence between an identifier of a first local area network and an identifier of an uplink data tunnel from a control plane network element, where the uplink data tunnel is used to transmit multicast data of the first local area network to a multicast service management network element. The user plane network element receives first multicast data of the first local area network, determines, based on the correspondence, an uplink data tunnel corresponding to the first local area network, and sends the first multicast data to the multicast service management network element through the uplink data tunnel corresponding to the first local area network. According to this embodiment of this application, efficiency and accuracy of transmitting the multicast data of the first local area network by the user plane network element to the multicast service management network element can be improved, and applicability is high.

According to a fourth aspect, a data transmission method is provided and is applied to an access network device side. The method includes the following steps. An access network device receives information about a first multicast transmission path from a control plane network element, where the first multicast transmission path is used to broadcast multicast data of a first local area network. The access network device broadcasts the information about the first multicast transmission path to a terminal device in the first local area network. Herein, after receiving the information about the first multicast transmission path, the terminal device may store the information about the first multicast transmission path, and may further listen to the multicast data of the first local area network on the first multicast transmission path. When the access network device receives, through the first multicast transmission path, multicast data broadcast by a multicast service management network element, the access network device broadcasts the received multicast data to the terminal device in the first local area network. It should be noted herein that because a terminal device that does not receive the information about the first multicast transmission path cannot learn of the information about the first multicast transmission path, the terminal device cannot listen to the multicast data of the first local area network on the first multicast transmission path. For example, a terminal device, in a local area network, other than the first local area network cannot learn of the information about the dedicated first multicast transmission path of the first local area network, and therefore cannot detect the multicast data of the first local area network through listening. In this embodiment of this application, resource utilization of the first multicast transmission path can be improved, and transmission security of multicast transmission in the first local area network can also be improved.

According to a fifth aspect, a data transmission method is provided and is applied to a terminal device side. The method includes the following steps. A terminal device receives information about a first multicast transmission path from an access network device, where the first multicast transmission path is used to broadcast multicast data of a first local area network to which the terminal device belongs. The terminal device receives, through the first multicast transmission path, the multicast data of the first local area network broadcast by the access network device. In this embodiment of this application, the multicast service management network element does not need to add the multicast data of the first local area network to a downlink bearer of each terminal device in the local area network. This can reduce air interface signaling overheads for data exchange of the terminal devices in the first local area network, and improve utilization of air interface resources, and applicability is higher.

According to a sixth aspect, a multicast service management network element is provided. The multicast service management network element includes units and/or modules configured to perform the data transmission method provided in the first aspect and/or any possible implementation of the first aspect, and therefore, can also implement beneficial effects (or advantages) of the data transmission method provided in the first aspect.

According to a seventh aspect, a control plane network element is provided. The control plane network element includes units and/or modules configured to perform the data transmission method provided in the second aspect and/or any possible implementation of the second aspect, and therefore, can also implement beneficial effects (or advantages) of the data transmission method provided in the second aspect.

According to an eighth aspect, a user plane network element is provided. The user plane network element includes units and/or modules configured to perform the data transmission method provided in the third aspect, and therefore, can also implement beneficial effects (or advantages) of the data transmission method provided in the third aspect.

According to a ninth aspect, an access network device is provided. The access network device includes units and/or modules configured to perform the data transmission method provided in the fourth aspect, and therefore, can also implement beneficial effects (or advantages) of the data transmission method provided in the fourth aspect.

According to a tenth aspect, a terminal device is provided. The terminal device includes units and/or modules configured to perform the data transmission method provided in the fifth aspect, and therefore, can also implement beneficial effects (or advantages) of the data transmission method provided in the fifth aspect.

According to an eleventh aspect, a multicast service management network element is provided, and the multicast service management network element includes a memory, a processor, a receiver, and a transmitter. The processor is configured to invoke data transmission program code stored in the memory, to perform the data transmission method provided in the first aspect and/or any possible implementation of the first aspect.

According to a twelfth aspect, a control plane network element is provided, and the control plane network element includes a memory, a processor, a receiver, and a transmitter. The processor is configured to invoke data transmission program code stored in the memory, to perform the data transmission method provided in the second aspect and/or any possible implementation of the second aspect.

According to a thirteenth aspect, a user plane network element is provided, and the user plane network element includes a memory, a processor, a receiver, and a transmitter. The processor is configured to invoke data transmission program code stored in the memory, to perform the data transmission method provided in the third aspect.

According to a fourteenth aspect, an access network device is provided, and the access network device includes a memory, a processor, a receiver, and a transmitter. The processor is configured to invoke data transmission program code stored in the memory, to perform the data transmission method provided in the fourth aspect.

According to a fifteenth aspect, a terminal device is provided, and the terminal device includes a memory, a processor, a receiver, and a transmitter. The processor is configured to invoke data transmission program code stored in the memory, to perform the data transmission method provided in the fifth aspect.

According to a sixteenth aspect, embodiments of this application provide a communications system. The system includes the multicast service management network element provided in the sixth aspect, the control plane network element provided in the seventh aspect, the user plane network element provided in the eighth aspect, the access network device provided in the ninth aspect, and the terminal device provided in the tenth aspect.

According to a seventeenth aspect, embodiments of this application provide a computer storage medium, used to store a computer software instruction used by a multicast service management network element in the data transmission method provided in the first aspect. The instruction includes a program required by the multicast service management network element to perform the designed manner in the first aspect.

According to an eighteenth aspect, embodiments of this application provide a computer storage medium, used to store a computer software instruction used by a control plane network element in the data transmission method provided in the second aspect. The instruction includes a program required by the control plane network element to perform the designed manner in the second aspect.

According to a nineteenth aspect, embodiments of this application provide a computer storage medium, used to store a computer software instruction used by a user plane network element in the data transmission method provided in the third aspect. The instruction includes a program required by the user plane network element to perform the designed manner in the third aspect.

According to a twentieth aspect, embodiments of this application provide a computer storage medium, used to store a computer software instruction used by an access network device in the data transmission method provided in the fourth aspect. The instruction includes a program required by the access network device to perform the designed manner in the fourth aspect.

According to a twenty-first aspect, embodiments of this application provide a computer storage medium, used to store a computer software instruction used by a terminal device in the data transmission method provided in the fifth aspect. The instruction includes a program required by the terminal device to perform the designed manner in the fifth aspect.

According to a twenty-second aspect, embodiments of this application further provide a chip. The chip is coupled to a transceiver in a multicast service management network element, to perform the technical solution provided in the first aspect of the embodiments of this application. It should be understood that “coupling” in the embodiments of this application means that two components are directly or indirectly combined with each other. Such combination may be fixed or mobile. Such combination may allow communication of a fluid, electricity, an electrical signal, or a signal of another type between the two components.

According to a twenty-third aspect, embodiments of this application further provide a chip. The chip is coupled to a transceiver in a control plane network element, to perform the technical solution provided in the second aspect of the embodiments of this application.

According to a twenty-fourth aspect, embodiments of this application further provide a chip. The chip is coupled to a transceiver in a user plane network element, to perform the technical solution provided in the third aspect of the embodiments of this application.

According to a twenty-fifth aspect, embodiments of this application further provide a chip. The chip is coupled to a transceiver in an access network device, to perform the technical solution provided in the fourth aspect of the embodiments of this application.

According to a twenty-sixth aspect, embodiments of this application further provide a chip. The chip is coupled to a transceiver in a terminal device, to perform the technical solution provided in the fifth aspect of the embodiments of this application.

According to a twenty-seventh aspect, embodiments of this application provide a chip system. The chip system includes a processor, configured to support a multicast service management network element in implementing functions in the first aspect, for example, generating or processing information in the data transmission method provided in the first aspect. In a possible design, the chip system further includes a memory. The memory is configured to store a program instruction and data that are necessary for the multicast service management network element. The chip system may include a chip, or may include a chip and another discrete component.

According to a twenty-eighth aspect, embodiments of this application provide a chip system. The chip system includes a processor, configured to support a multicast service management network element in implementing functions in the first aspect, for example, generating or processing information in the data transmission method provided in the first aspect. In a possible design, the chip system further includes a memory. The memory is configured to store a program instruction and data that are necessary for the multicast service management network element. The chip system may include a chip, or may include a chip and another discrete component.

According to a twenty-ninth aspect, embodiments of this application provide a chip system. The chip system includes a processor, configured to support a control plane network element in implementing functions in the second aspect, for example, generating or processing information in the data transmission method provided in the second aspect. In a possible design, the chip system further includes a memory. The memory is configured to store a program instruction and data that are necessary for the control plane network element. The chip system may include a chip, or may include a chip and another discrete component.

According to a thirtieth aspect, embodiments of this application provide a chip system. The chip system includes a processor, configured to support a user plane network element in implementing functions in the third aspect, for example, generating or processing information in the data transmission method provided in the third aspect. In a possible design, the chip system further includes a memory. The memory is configured to store a program instruction and data that are necessary for the user plane network element. The chip system may include a chip, or may include a chip and another discrete component.

According to a thirty-first aspect, embodiments of this application provide a chip system. The chip system includes a processor, configured to support an access network device in implementing functions in the fourth aspect, for example, generating or processing information in the data transmission method provided in the fourth aspect. In a possible design, the chip system further includes a memory. The memory is configured to store a program instruction and data that are necessary for the access network device. The chip system may include a chip, or may include a chip and another discrete component.

According to a thirty-second aspect, embodiments of this application provide a chip system. The chip system includes a processor, configured to support a terminal device in implementing functions in the fifth aspect, for example, generating or processing information in the data transmission method provided in the fifth aspect. In a possible design, the chip system further includes a memory. The memory is configured to store a program instruction and data that are necessary for the terminal device. The chip system may include a chip, or may include a chip and another discrete component.

According to the embodiments of this application, air interface signaling overheads for multicast data transmission in a local area network can be reduced, and utilization of air interface resources can be improved. In addition, security of multicast data transmission in the local area network can be improved, and applicability is higher.

### BRIEF DESCRIPTION OF DRAWINGS

FIG. 1 shows a basic architecture of a communications system, in accordance with one or more embodiments.

FIG. 2 is a schematic architectural diagram of an eMBMS data transmission system, in accordance with one or more embodiments.

FIG. 3 is another schematic architectural diagram of a data transmission system, in accordance with one or more embodiments.

FIG. 4A and FIG. 4B are a schematic flowchart of a data transmission method, in accordance with one or more embodiments.

FIG. 5A and FIG. 5B are another schematic flowchart of a data transmission method, in accordance with one or more embodiments.

FIG. 6A and FIG. 6B are another schematic flowchart of a data transmission method, in accordance with one or more embodiments.

FIG. 7 is a schematic structural diagram of a multicast service management network element, in accordance with one or more embodiments.

FIG. 8 is a schematic structural diagram of a control plane network element, in accordance with one or more embodiments.

FIG. 9 is a schematic structural diagram of a user plane network element, in accordance with one or more embodiments.

FIG. 10 is a schematic structural diagram of an access network device, in accordance with one or more embodiments.

FIG. 11 is a schematic structural diagram of a terminal device, in accordance with one or more embodiments.

FIG. 12 is a schematic structural diagram of a communications device, in accordance with one or more embodiments.

### DESCRIPTION OF EMBODIMENTS

A data transmission method provided in the embodiments of this application may be applied to a long term evolution (LTE) system or other wireless communications systems that use various radio access technologies, for example, systems that use access technologies such as code division multiple access (CDMA), frequency division multiple access (FDMA), time division multiple access (TDMA), orthogonal frequency division multiple access (OFDMA), and single carrier frequency division multiple access (SC-FDMA), and the data transmission method is also applied to a subsequent evolved system, such as a 5G (or referred to as a new radio (NR)) system.

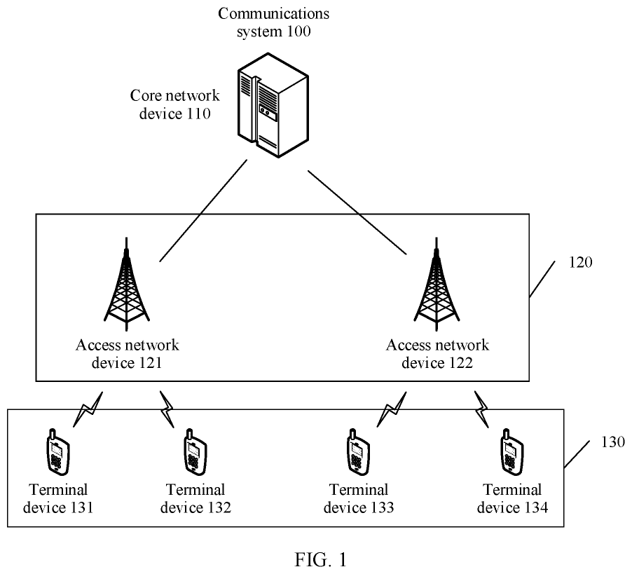

FIG. 1 shows a basic architecture of a communications system according to an embodiment of this application. The communications system 100 provided in this embodiment of this application may include a core network device 110, access network devices 120, and terminal devices 130. As shown in FIG. 1, the access network devices 120 described in this embodiment of this application may include an access network device 121 and an access network device 122, and the terminal devices 130 may include a terminal device 131, a terminal device 132, a terminal device 133, and a terminal device 134. Optionally, the access network device 121 may be an access network device in a local area network (for example, a local area network 1), for example, an access network device in a cell 1 in the local area network 1. The terminal device 131 and the terminal device 132 may access the local area network 1 by using the access network device 121, and obtain multicast data of the local area network 1 by using the access network device 121. The access network device 122 may be another access network device in the local area network 1, for example, an access network device in a cell 2 in the local area network 1. The access network device 122 may alternatively be an access network device in another local area network (for example, a local area network 2). The terminal device 133 and the terminal device 134 may access the local area network 1 (or the local area network 2) by using the access network device 122, and obtain multicast data of the local area network 1 (or the local area network 2) by using the access network device 122. The access network device 121, the access network device 122, the terminal device 131, the terminal device 132, the terminal device 133, and the terminal device 134 are merely examples. The communications system 100 provided in this embodiment of this application includes but is not limited to the foregoing network devices. This is not limited herein. A quantity of access network devices and a quantity of terminal devices included in the communications system 100 provided in this embodiment of this application are not limited herein either.

The terminal device in this application may also be referred to as user equipment (UE), an access terminal, a subscriber unit, a subscriber station, a mobile station, a remote station, a remote terminal, a mobile device, a user terminal, a terminal, a wireless communications device, a user agent, a user apparatus, or the like. This is not limited herein. UE is a name of the terminal device in the LTE system. The terminal device provided in the embodiments of this application may be a device providing voice and/or data connectivity for a user, and may include a wireless terminal and a wired terminal. The wireless terminal may be a handheld device with a radio connection function, or another processing device connected to a radio modem, or may be a mobile terminal that communicates with one or more core networks by using a radio access network. For example, the wireless terminal may be a mobile phone, a computer, a tablet computer, a personal digital assistant (PDA), a mobile internet device (MID), a wearable device, or an e-book reader. For another example, the wireless terminal may also be a portable, pocket-sized, handheld, computer built-in, or in-vehicle mobile device. For another example, the wireless terminal may be a mobile station or an access point. For ease of description, in a subsequent description of this application, an example in which the devices of various names described above are referred to as a terminal device is used for description.

The access network device provided in the embodiments of this application is mainly responsible for functions on an air interface side, such as radio resource management, quality of service (QoS) management, and data compression and encryption. Optionally, the access network device in the embodiments of this application may be a base station, and the base station is an apparatus that is deployed in a radio access network (RAN) and that is configured to provide a radio communications function for the terminal device and broadcast data and/or multicast data. The base station may include a macro base station, a micro base station, a relay site, an access point, a base station controller, a transmission reception point (TRP), and the like in various forms. Specific names of the base station in systems using different radio access technologies may be different. For example, in an LTE network, the base station is referred to as an evolved NodeB (eNB), and in a subsequent evolved system, the base station may also be referred to as a new radio NodeB (gNB). For ease of description, in a subsequent description of this application, the devices described above are collectively referred to as an access network device.

The core network device 10 provided in this embodiment of this application may include a core network user plane network element (or referred to as a user plane network element for short) and a core network control plane network element (or referred to as a control plane network element for short).

The core network user plane network element receives a data packet from a terminal device, and forwards the data packet.

The core network control plane network element may define a data packet processing action of the user plane network element, and the core network control plane network element sends a data packet forwarding rule to the core network user plane network element. When the data packet arrives at the core network user plane network element, the core network user plane network element performs corresponding processing on the data packet according to the forwarding rule delivered by the core network control plane network element, and forwards the data packet. The core network control plane network element may store one or more types of information about the terminal device. The information about the terminal device may include at least one of an identifier of the terminal device, information about a local area network to which the terminal device belongs, information about a multicast group to which the terminal device belongs, and information about an access network device to which the terminal device belongs. The information about the terminal device that is stored in the core network control plane network element includes but is not limited to the foregoing information. This is not limited herein.

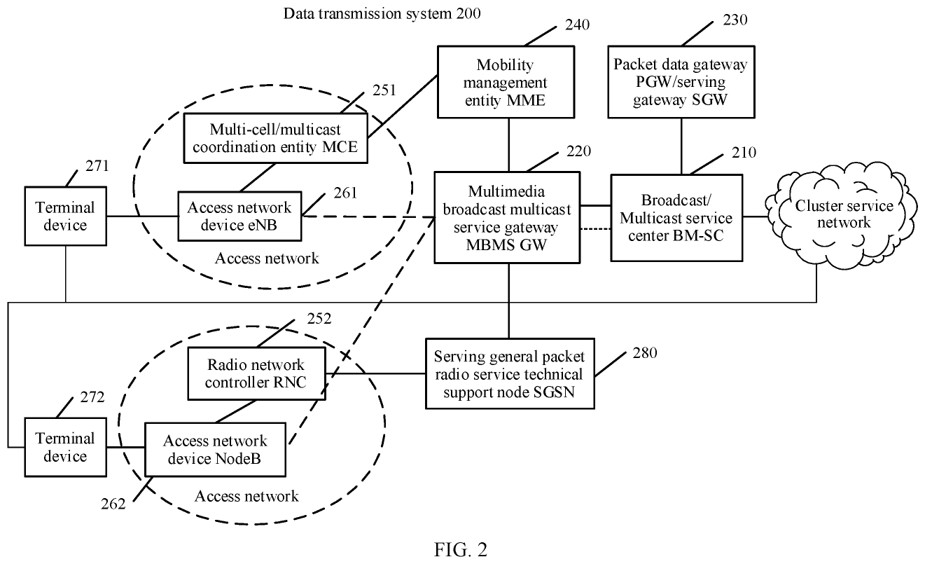

The third generation partnership project (3GPP) multimedia broadcast multicast service (MBMS) is a data transmission system that supports delivering service data through an air interface in a broadcast mode, and includes an evolved multimedia broadcast multicast service (eMBMS) system and the like. For ease of description, the following uses a data transmission system of an eMBMS (or referred to as an eMBMS data transmission system) as an example for description. The data transmission method provided in the embodiments of this application is applicable to the eMBMS data transmission system, and the eMBMS data transmission system also includes a terminal device, an access network device, and a core network device. The core network device includes at least one control plane network element responsible for different functions and at least one user plane network element responsible for different functions. FIG. 2 is a schematic architectural diagram of an eMBMS data transmission system. The data transmission system 200 includes the following network elements: a broadcast/multicast service center (BM-SC) 210, a multimedia broadcast multicast service gateway (MBMS gateway, MBMS GW) 220, a packet data gateway (PGW) and/or serving gateway (SGW) 230, a mobility management entity (MME) 240, a multi-cell/multicast coordination entity (MCE) 251, a radio network controller (RNC) 252, an access network device 261, an access network device 262, a terminal device 271, a terminal device 272, a serving general packet radio service technical support node (SGSN) 280, and the like. In FIG. 2, a solid line “—” indicates a control plane connection between network elements, and a dashed line “- - -” indicates a data plane connection between network elements.

As shown in FIG. 2, the BM-SC is a core control unit in the data transmission system 200. The BM-SC may obtain third-party service data from a content provider, and may perform a full-service service such as service control and service transmission of a third-party service based on a requirement of the third-party service data. The third-party service data may be understood as service data of a cluster service network. In the cluster service network, a group communication service application server (GCSAS) may provide service data for the BM-SC and the GSCAS participates in access control and another process of a terminal device. The BM-SC may implement functions such as MBMS service announcement, service management, user management, security, charging function, data forwarding, and content synchronization. The MBMS service announcement may be understood as broadcasting information about an MBMS service, and the BM-SC may notify, through broadcast, the terminal device of information about an MBMS service managed by the BM-SC. The information about the MBMS service may include a data broadcast path of the MBMS service. The terminal device may learn of the data broadcast path of the MBMS service through the MBMS service announcement, and may further listen to data of the MBMS service on the data broadcast path. For the content provider, the BM-SC is an entrance for MBMS service content. For a data transmission network (or referred to as a bearer network), the BM-SC is responsible for authorizing and initiating an MBMS service, scheduling and transmitting MBMS service content, and the like. The MBMS service content may also be referred to as MBMS service data.

The terminal device 271 may be understood as a terminal device belonging to the cluster service network, and the terminal device 271 may obtain MBMS service data of the cluster service network by using the access network device 261. The terminal device 272 may be understood as another terminal device belonging to the cluster service network, and the terminal device 272 may also obtain MBMS service data of the cluster service network by using the access network device 262.

The BM-SC may provide a function of a core network control plane network element, and may be understood as one of core network control plane network elements in the data transmission system 200. The core network control plane network elements in the data transmission system 200 may further include the MBMS GW 220, the MME 240, and the SGSN 280. Network elements such as the MCE 251 and the RNC 252 in the data transmission system 200 may be understood as access network control plane network elements. The BM-SC 210 may control, by using network elements such as the MBMS GW 220, the MME 240, and the MCE 251 in an access network, service data transmitted to the access network device 261, and then may transmit the service data to the terminal device 271 by using the access network device 261. The BM-SC 210 may also control, by using network elements such as the MBMS GW 220, the SGSN 280, and the RNC 252 in an access network, service data transmitted to the access network device 262, and then may transmit the service data to the terminal device 272 by using the access network device 262.

A control plane of the MBMS GW 220 is responsible for processing an MBMS-specific message and an MBMS-specific parameter, allocating an internet protocol (IP) multicast address to an access network device that receives MBMS data, and forwarding the multicast address to the access network device 261 by using network elements such as the MME 240 and the MCE 251, or forwarding the multicast address to the access network device 262 by using network elements such as the SGSN 280 and the RNC 252. The MBMS GW 220 may further provide an MBMS charging function. The MBMS-specific message may include an MBMS session start message, and/or an MBMS bearer update message, and/or an MBMS session stop message. The MBMS-specific parameter may include an MBMS service area and/or an MBMS control plane node list.

The MBMS GW 220 may also provide a function of a core network user plane network element, and a user plane of the MBMS GW 200 is responsible for broadcasting and/or multicasting, to each access network device (for example, the access network device 261 or the access network device 262) through IP, MBMS service data that is from the BM-SC 210, and transmitting the MBMS service data to a terminal device (for example, the terminal device 271 or the terminal device 272) by using the access network device (for example, the access network device 261 or the access network device 262).

The MME 240 receives MBMS service control information from the MBMS GW 220, performs session control on an MBMS bearer, and transmits session control information of the MBMS bearer to an access network device. The PGW and/or SGW 230 may be understood as a border gateway of the data transmission system 200, and provide functions such as session management and bearer control of a user (including the terminal device 271 and/or the terminal device 272) of an operator, data forwarding, IP address allocation, and non-3GPP user access. The SGSN 280 is an important component of a core network packet domain device, and mainly implements functions such as route forwarding of packet data packets, mobility management, session management, logical link management, authentication, encryption, and CDR generation and output.

In the data transmission system shown in FIG. 2, network elements in the access network include the access network device 261, the access network device 262, the MCE 251, and the RNC 252. The access network device 261 and the MCE 251 constitute a universal mobile telecommunications system terrestrial radio access network (UTRAN) in a 3G communications network, and the access network devices 262 and the RNC 252 constitute an evolved universal terrestrial radio access network (E-UTRAN) in an LTE network. The MCE 251 or the RNC 252 is responsible for efficiently transferring MBMS data to a specified MBMS service area, and can support an MBMS-related channel structure (including a memory controller hub (MCH), a multipoint control channel (MCCH), a multipoint time channel (MTCH), and the like), an IP multicast receiving function, and the like.

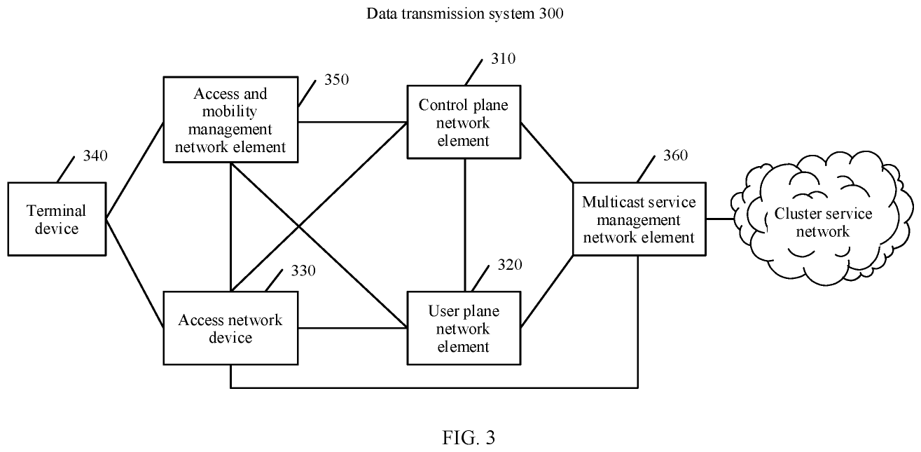

FIG. 3 is another schematic architectural diagram of a data transmission system according to an embodiment of this application. A data transmission system 300 provided in this embodiment of this application may be a data transmission system improved based on network elements included in the data transmission system 200. The data transmission system 300 may include a multicast service management network element 360, a control plane network element 310, a user plane network element 320, an access network device 330, and a terminal device 340. The multicast service management network element 360 may be configured to control to perform operations such as creating a multicast transmission path, deleting a multicast transmission path, and/or updating a multicast transmission path. It may be understood that the multicast service management network element 360 may be configured to implement all or some functions of the BM-SC 210 network element and all or some functions of the MBMS GW 220 in the data transmission system 200. This is not limited herein.

In this embodiment of this application, an interface between the control plane network element 310 and the multicast service management network element 360 and an interface between the user plane network element 320 and the multicast service management network element 360 in a local area network are newly added. The control plane network element 310 is responsible for access verification and authorization of a multicast transmission path of a terminal device, and sends description information of the multicast transmission path to the terminal device by using the access network device after access verification and authorization of the terminal device succeed. The control plane network element 310 may further initiate a multicast transmission path update process to the multicast service management network element 360 based on a status of the terminal device (for example, location movement information of the terminal device or a QoS change request of the terminal device), to adjust a service area of the multicast transmission path in real time. The service area of the multicast transmission path may be a multicast area and/or a broadcast area of the multicast transmission path. It may be understood that the control plane network element 310 may be configured to implement some or all functions of the control plane of the MBMS GW 220 in the data transmission system 200. This is not limited herein.

The user plane network element 320 may be configured to perform an operation such as data distribution on the multicast transmission path. It may be understood that the user plane network element 320 may be configured to implement some or all functions of the PGW and/or SGW 230 in the data transmission system 200. This is not limited herein.

As shown in FIG. 3, the data transmission system 300 may further include an access and mobility management network element 350. The access and mobility management network element may be configured to implement all or some functions of network elements such as the MME 240, the SGSN 280, the MCE 251, and the RNC 252 in the data transmission system 200 shown in FIG. 2. This may be determined based on an actual application scenario, and is not limited herein.

The method provided in the embodiments of this application may be applied to the data transmission system 300 shown in FIG. 3. The data transmission system 300 may perform, by using network elements and/or devices included in the data transmission system 300, the data transmission method provided in the following embodiments of this application.

Optionally, the multicast transmission path described below in the embodiments of this application may include a multicast bearer (for example, an MBMS bearer) and/or a multicast session (for example, an MBMS session). This may be determined based on an actual application scenario, and is not limited herein. For ease of description, the multicast transmission path is used as an example for description in subsequent embodiments of this application. The multicast data provided in the embodiments of this application may include multicast data and/or broadcast data. This is not limited herein.

Optionally, an example in which a local switching network provided in the embodiments of this application is a local area network is described.

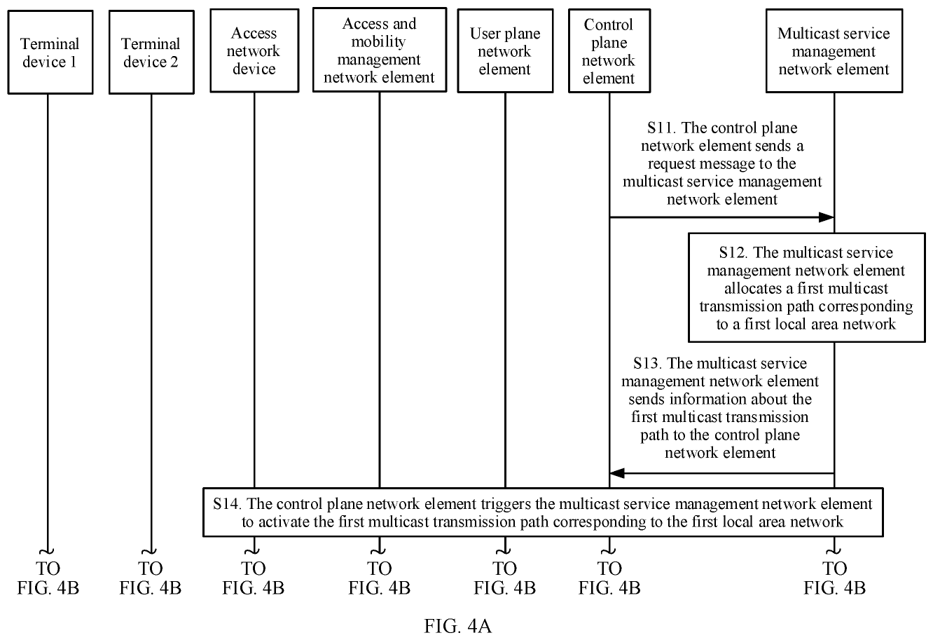

FIG. 4A and FIG. 4B are a schematic flowchart of a data transmission method according to an embodiment of this application. The data transmission method provided in this embodiment of this application includes the following steps.

S11. A control plane network element sends a request message to a multicast service management network element.

In a feasible implementation, after a terminal device 1 and a terminal device 2 attach to a first local area network (a local area network 1 for short below), the control plane network element may send the request message to the multicast service management network element, to trigger the multicast service management network element to allocate a dedicated multicast transmission path to the local area network 1. The multicast transmission path is connected to the multicast service management network element and an access network device. For example, the multicast transmission path is an MBMS bearer. The multicast transmission path is used for multicasting and/or broadcasting (the following uses broadcasting as an example for description) multicast data. For example, the dedicated multicast transmission path of the local area network 1 is used for broadcasting multicast data of the local area network 1. For example, the dedicated MBMS bearer of the local area network 1 is used to broadcast multicast data of a terminal device in the local area network 1 to an access network device in the local area network 1, and the access network device broadcasts the multicast data to another terminal device in the local area network 1.

The request message may carry information about the local area network 1. For example, the information about the local area network 1 may include an identity (ID) of the local area network 1 and information about a cell covered by the local area network 1.

It may be understood that the terminal device 1 and the terminal device 2 described in this embodiment of this application are merely two examples in the local area network 1, and there may be more terminal devices other than the terminal device 1 and the terminal device 2 in the local area network 1. The dedicated MBMS bearer of the local area network 1 may be used to broadcast multicast data of a terminal device (for example, the terminal device 1) in the local area network 1 to the access network device in the local area network 1, and the access network device broadcasts the multicast data of the local area network 1 to the terminal device 2, a terminal device 3, . . . , and a terminal device N in the local area network 1.

S12. The multicast service management network element allocates a first multicast transmission path corresponding to the first local area network.

S13. The multicast service management network element sends information about the first multicast transmission path to the control plane network element.

In a feasible implementation, after receiving the information about the local area network 1 sent by the control plane network element, the multicast service management network element may allocate the first multicast transmission path (a multicast transmission path 1 for short below) corresponding to the local area network 1. The multicast transmission path 1 is a dedicated multicast transmission path of the local area network 1, and the multicast transmission path 1 is used to broadcast the multicast data of the local area network 1.

The multicast service management network element may feed the information about the multicast transmission path 1 back to the control plane network element. The information about the multicast transmission path 1 includes information about a local area network (namely, the local area network 1) associated with the multicast transmission path 1 and an identifier of the multicast transmission path 1. Optionally, the information about the multicast transmission path 1 may further include a use period of the multicast transmission path 1. The identifier of the multicast transmission path may be a temporary mobile group identity (TMGI).

Optionally, the control plane network element may bind the identifier of the multicast transmission path 1 to the information about the local area network 1, to determine a correspondence between the multicast transmission path 1 and the local area network 1, and further to subsequently broadcast the multicast data of the local area network 1.

S14. The control plane network element triggers the multicast service management network element to activate the first multicast transmission path corresponding to the first local area network.

In a feasible implementation, after determining that the multicast service management network element allocates the dedicated first multicast transmission path (the multicast transmission path 1) to the local area network 1, the control plane network element may trigger the multicast service management network element to activate the multicast transmission path 1. In a specific implementation, for a process of activating the dedicated multicast transmission path of the local area network 1, refer to a process of activating an MBMS bearer in an eMBMS data transmission system. This is not limited herein.

After the multicast transmission path 1 is activated, when multicast data needs to be broadcast in the local area network 1, the multicast service management network element may broadcast the multicast data of the local area network 1 to the access network device in the local area network 1 through the multicast transmission path 1. The multicast data of the local area network 1 may include MBMS service data of any one or more terminal devices in the terminal device 1, the terminal device 2, . . . , and the terminal device N in the local area network 1.

S15. The control plane network element sends the information about the first multicast transmission path to the access network device in the first local area network, and the access network device broadcasts the information about the first multicast transmission path to a terminal device in the first local area network.

In a feasible implementation, the control plane network element may separately send the information about the multicast transmission path 1 to access network devices connected to the terminal device 1 and the terminal device 2, to broadcast the information about the multicast transmission path 1 to the terminal device 1 by using an access network device (for example, an access network device 1) connected to the terminal device 1, and broadcast the information about the multicast transmission path 1 to the terminal device 2 by using an access network device (for example, an access network device 2) connected to the terminal device 2. For example, in an attachment (or registration) process in which the terminal device 1 attaches to (or registers with) the local area network 1, the control plane network element may store an identifier of the access network device (for example, the access network device 1) connected to the terminal device 1. When needing to send the information about the multicast transmission path 1 to the terminal device 1, the control plane network element may send the information about the multicast transmission path 1 to the access network device 1, and then the access network device 1 broadcasts the identifier of the multicast transmission path 1 to the terminal device 1. Similarly, in an attachment (or registration) process in which the terminal device 2 attaches to (or registers with) the local area network 1, the control plane network element may store an identifier of the access network device (for example, the access network device 1) connected to the terminal device 2. When needing to send the information about the multicast transmission path 1 to the terminal device 2, the control plane network element may send the information about the multicast transmission path 1 to the access network device 2, and then the access network device 2 broadcasts the identifier of the multicast transmission path 1 to the terminal device 2.

Optionally, the access network device 1 and the access network device 2 may be a same access network device, in other words, the terminal device 1 and the terminal device 2 may be connected to a same access network device. The access network device broadcasts the information about the multicast transmission path 1 to terminal devices (for example, the terminal device 1 and/or the terminal device 2) served by the access network device.

The terminal device 1 (and/or the terminal device 2) may determine, based on the information about the multicast transmission path 1 received from the access network device, that the local area network associated with the multicast transmission path 1 is the local area network 1, and then may update a network layer bearer based on the information about the multicast transmission path 1. After the network layer bearer is updated, if multicast data needs to be broadcast in the local area network 1, the terminal device 1 (and/or the terminal device 2) may receive the multicast data of the local area network 1 from the access network device 1 (and/or the access network device 2). The access network device 1 (and/or the access network device 2) may receive the multicast data of the local area network 1 from the multicast service management network element.

For example, if the access network device 1 wants to receive the multicast data of the local area network 1 from the multicast service management network element, the access network device 1 needs to know a multicast transmission path on which the multicast service management network element broadcasts the multicast data of the local area network 1. The access network device 1 needs to learn of the information such as the identifier of the dedicated multicast transmission path 1 of the local area network 1, and then can listen to, on the multicast transmission path, whether the multicast data of the local area network 1 is broadcast by the multicast service network element. Similarly, it can be understood that if the terminal device 1 wants to receive the multicast data of the local area network 1 from the access network device, the terminal device 1 also needs to learn of a multicast transmission path on which the access network device 1 broadcasts the multicast data of the local area network 1. The terminal device 1 needs to learn of the information such as the identifier of the multicast transmission path 1, and then can listen to, on the multicast transmission path, whether the access network device broadcasts the multicast data of the local area network 1.

S16. The control plane network element sends a correspondence between an identifier of the first local area network and an identifier of an uplink data tunnel to a user plane network element.

In a feasible implementation, in step S11, the control plane network element sends the request message to the multicast service management network element, and the request message may also be used to trigger the multicast service management network element to allocate a dedicated uplink data tunnel to the local area network 1. The multicast service management network element may allocate, based on the identifier of the local area network 1 carried in the request message, an uplink data tunnel (an uplink data tunnel 1 for short below) corresponding to the local area network 1, generate an identifier of the uplink data tunnel 1, and feed the identifier of the uplink data tunnel 1 back to the control plane network element.

The uplink data tunnel 1 of the multicast service management network element may be used to transmit the multicast data of the local area network 1. The uplink data tunnel 1 is an uplink data transmission path from the user plane network element to the multicast service management network element.

The control plane network element may send the correspondence between the identifier of the local area network 1 (for example, an ID of the local area network 1) and the identifier of the uplink data tunnel 1 to the user plane network element. The correspondence is used to indicate that the uplink data tunnel 1 is a dedicated uplink data tunnel of the local area network 1, and the user plane network element may send the multicast data of the local area network 1 to the multicast service management network element through the uplink data tunnel. When receiving the multicast data from the access network device in the local area network 1, the user plane network element may send the multicast data to the multicast service management network element through the uplink data tunnel 1.

Optionally, the correspondence may also be referred to as a data forwarding rule for performing sending from the control plane network element to the user plane network element. This is not limited herein. The data forwarding rule is used to instruct the user plane network element to send the multicast data of the local area network 1 through the uplink data tunnel 1.

S17. The terminal device 1 sends multicast data to the access network device 1, and the access network device 1 sends the multicast data of the terminal device 1 to the user plane network element.

In a feasible implementation, when the terminal device 1 in the local area network 1 needs to transmit the multicast data, the terminal device 1 may send the multicast data to the access network device 1 connected to the terminal device 1, and then forward the multicast data to the user plane network element by using the access network device 1. The multicast data may be MBMS service data. For example, the terminal device 1 may send the multicast data to the user plane network element in a form of a multicast packet and/or a broadcast packet.

S18. The user plane network element sends the multicast data of the first local area network to the multicast service management network element.

For example, in an attachment (or registration) process in which the terminal device 1 attaches to (or registers with) the local area network 1, the terminal device 1, the access network device 1, and the user plane network element all participate in the attachment (or registration) process of the terminal device. An access network device to which the terminal device 1 attaches is the access network device 1, and the user plane network element may learn that a local area network to which the access network device 1 belongs is the local area network 1. After the terminal device 1 successfully attaches, the user plane network element may store an identifier (for example, an association between the identifier of the local area network 1 and an identifier of the access network device) of the local area network (namely, the local area network 1) to which the access network device 1 belongs. After the multicast data of the terminal device 1 is sent to the access network device 1, the access network device 1 may send the multicast data to the user plane network element. After receiving the multicast data from the access network device 1, the user plane network element may determine, based on the stored association, that a local area network to which the access network device 1 belongs is the local area network 1, and may further determine that the multicast data is the multicast data of the local area network 1. The user plane network element may send the multicast data to the multicast service management network element through the uplink data tunnel 1. For example, after determining that the multicast data received from the access network device 1 is the multicast data of the local area network 1, the user plane network element may determine, based on the stored correspondence between the identifier of the local area network 1 and the identifier of the uplink data tunnel 1, that the dedicated uplink data tunnel of the local area network 1 is the uplink data tunnel 1, and may further send the multicast data to the multicast service management network element through the uplink data tunnel 1.

For the attachment process in which the terminal device 1 attaches to the local area network 1, refer to related implementations in which the terminal device attaches to and detaches from an LTE network or the terminal device registers and deregisters in a 5G network. This is not limited herein. In the following description, that the terminal device 1 attaches to the local area network 1 may also means that the terminal device 1 registers with the local area network 1. This is not limited herein.

S19. The multicast service management network element broadcasts the multicast data of the first local area network to the access network device in the first local area network through the first multicast transmission path.

For example, after receiving multicast data, if the multicast service management network element determines that an identifier of an uplink data tunnel receiving the multicast data is the same as the identifier of the uplink data tunnel 1, the multicast service management network element may determine that the multicast data is from the local area network 1. The multicast service management network element broadcasts the multicast data to the access network device in the local area network 1 through the multicast transmission path 1, and the access network device in the local area network 1 broadcasts the MBMS service data to terminal devices in the local area network 1. The terminal devices in the local area network 1 may separately receive the multicast data from access network devices connected to the terminal devices.

In this embodiment of this application, in an eMBMS multicast broadcast mechanism, the multicast service management network element may broadcast multicast data of any terminal device (for example, the terminal device 1) in the local area network 1 to the access network device in the local area network 1, and other terminal devices (for example, a terminal device other than the terminal device 1) in the local area network 1 may separately receive the multicast data from access network devices connected to the other terminal devices. The multicast service management network element does not need to add the MBMS service data of the terminal device 1 to a downlink bearer of each terminal device in the local area network. This can reduce air interface signaling overheads for data exchange of terminal devices in the local area network 1 and improve utilization of air interface resources, and applicability is higher.

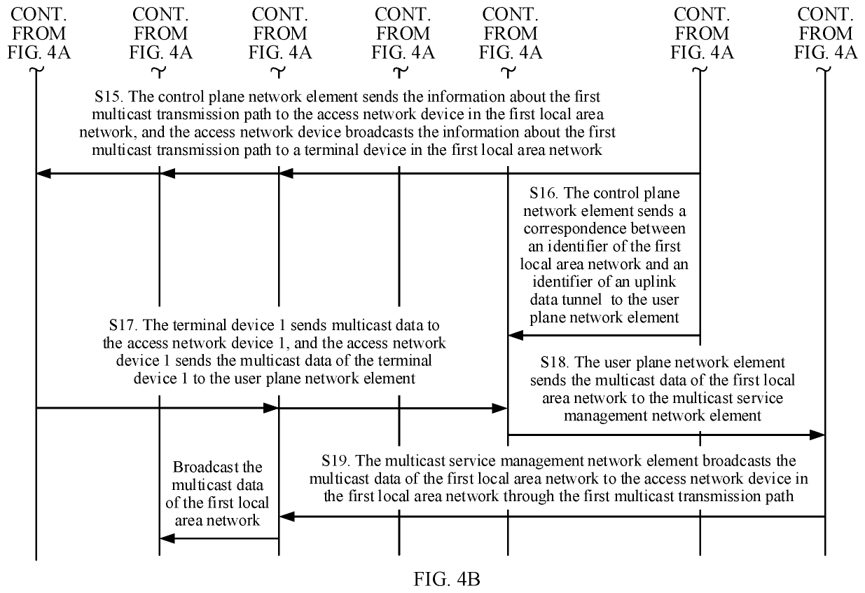

In an optional implementation, the terminal device 1 and the terminal device 2 may attach to a same local area network, for example, the local area network 1. Before requesting the multicast service management network element to allocate the dedicated multicast transmission path of the local area network 1, the control plane network element may first establish a connection to the multicast service management network element, and request the multicast service management network element to allocate the dedicated uplink data tunnel of the local area network 1. FIG. 5A and FIG. 5B are another schematic flowchart of a data transmission method according to an embodiment of this application. The data transmission method provided in this embodiment of this application may include the following steps.

S21. A terminal device 1 and a terminal device 2 attach to a first local area network.

In a feasible implementation, when the terminal device 1 and the terminal device 2 attach to a same access network device, or attach to two different access network devices that cover a same cell, creation of a local area network may be triggered, and it is assumed that the local area network is a local area network 1. The local area network 1 may alternatively be referred to as the first local area network. This is not limited herein. A cell covered by the local area network 1 may include a cell in which the terminal device 1 and the terminal device 2 are located, for example, a cell 1. Optionally, when a terminal device in another cell accesses the local area network 1, a cell covered by the local area network 1 may be changed into the cell 1 and the another cell. The terminal device 1 and the terminal device 2 may exchange location information by using the local area network 1, or may exchange multicast data by using the local area network 1.

S22. A control plane network element sends a connection request message to a multicast service management network element.

In a feasible implementation, the control plane network element may send the connection request message to the multicast service management network element, to request to allocate a dedicated uplink data tunnel of the local area network 1. The connection request message carries an identifier of a local area network (an identifier of the local area network 1), to trigger, by using the message, the multicast service management network element to allocate the dedicated uplink data tunnel of the local area network 1. For example, the control plane network element sends the connection request message to the multicast service management network element, and the connection request message includes the identifier of the local area network 1. After receiving the connection request message, the multicast service management network element may allocate the dedicated uplink data tunnel (for example, an uplink data tunnel 1) to the local area network 1, and feed an identifier of the uplink data tunnel 1 back to the control plane network element. The connection request message may alternatively be a message in another representation form, and this is not limited herein.

The multicast service management network element may allocate, based on the identifier of the local area network 1, an uplink data tunnel (namely, the uplink data tunnel 1) corresponding to the local area network 1, and generate the identifier of the uplink data tunnel 1. The multicast service management network element may feed the identifier of the uplink data tunnel 1 back to the control plane network element, to forward the identifier of the uplink data tunnel 1 to a user plane network element by using the control plane network element.

S23. The control plane network element sends a correspondence between the identifier of the first local area network and the identifier of the uplink data tunnel to the user plane network element.

The control plane network element may send the correspondence between the identifier of the local area network 1 (for example, an ID of the local area network 1) and the identifier of the uplink data tunnel 1 to the user plane network element. The correspondence is used to indicate that the uplink data tunnel 1 is a dedicated uplink data tunnel of the local area network 1, and the user plane network element may send multicast data of the local area network 1 to the multicast service management network element through the uplink data tunnel 1.

Optionally, the correspondence may also be referred to as a data forwarding rule for performing sending from the control plane network element to the user plane network element. This is not limited herein.

After receiving the correspondence from the control plane network element, the user plane network element may store the correspondence for using in subsequent forwarding of multicast data to the multicast service management network element. For example, when receiving multicast data from an access network device in the local area network 1, the user plane network element may send the multicast data to the multicast service management network element through the uplink data tunnel 1.

S24. The control plane network element sends a request message to the multicast service management network element.

In a feasible implementation, the control plane network element may determine a cell set (or referred to as a serving cell set, and referred to as a first serving cell set for ease of description) based on a cell in which the terminal device 1 is located. The first serving cell set includes the cell covered by the local area network 1. For example, the first serving cell set includes at least the cell (for example, a cell 1) in which the terminal device 1 is located. If the local area network 1 further covers another cell, the first serving cell set may further include a cell adjacent to the cell 1. The control plane network element may determine that a cell included in the first serving cell set is a cell covered by the local area network 1, and may add information about the first serving cell set, namely, information about the cell covered by the local area network 1, to the request message to be sent to the multicast service management network element.

The multicast service management network element allocates a dedicated multicast transmission path (a multicast transmission path 1) to the local area network 1 based on the request message sent by the control plane network element, and may set, based on the cell covered by the local area network 1, a cell served by the dedicated multicast transmission path of the local area network 1.

S25. The multicast service management network element allocates a first multicast transmission path corresponding to the first local area network.

S26. The multicast service management network element sends information about the first multicast transmission path to the control plane network element.

For an implementation in which the multicast service management network element allocates the dedicated multicast transmission path of the local area network 1, and feeds the information about the dedicated multicast transmission path of the local area network 1 back to the control plane network element, refer to the implementations described in step S12 and step S13. Details are not described herein again.

S27. The control plane network element triggers the multicast service management network element to activate the first multicast transmission path corresponding to the first local area network.

For an implementation in which the control plane network element triggers the multicast service management network element to activate the dedicated multicast transmission path of the local area network 1, refer to step S14. Details are not described herein again.

S28. The control plane network element sends the information about the first multicast transmission path to the access network device in the first local area network, and the access network device broadcasts the information about the first multicast transmission path to a terminal device in the first local area network.

For an implementation in which the control plane network element sends the information about the dedicated multicast transmission path of the local area network 1 to the terminal device in the local area network 1 by using the access network device in the local area network 1, refer to step S15. Details are not described herein again.

S29. The terminal device 1 sends multicast data to the access network device 1, and the access network device 1 sends the multicast data of the terminal device 1 to the user plane network element.

For an implementation in which any terminal device (for example, the terminal device 1) in the local area network 1 sends multicast data to the user plane network element by using the access network device 1, refer to step S17. Details are not described herein again.

S30. The user plane network element sends the multicast data of the first local area network to the multicast service management network element.

For an implementation in which the user plane network element forwards the multicast data of the terminal device 1 to the multicast service management network element, refer to step S18. Details are not described herein again.

S31. The multicast service management network element broadcasts the multicast data of the first local area network to the access network device in the first local area network through the first multicast transmission path.

For an implementation in which the multicast service management network element broadcasts the multicast data of the local area network 1, refer to step S19. Details are not described herein again.

After determining that the multicast data is from the local area network 1, the multicast service management network element may encapsulate the multicast data, and broadcast the multicast data to the access network device in the local area network 1 through the multicast transmission path 1.

An access network device 2 connected to the terminal device 2 may obtain the multicast data from the local area network 1, and broadcast the multicast data to the terminal device 2 through the multicast transmission path 1. The terminal device 2 may obtain, from the access network device 2, the multicast data from the local area network 1, for example, the multicast data of the terminal device 1.

It may be understood that, when the terminal device 2 in the local area network 1 needs to transmit the multicast data to the terminal device 1 in the local area network 1 or another terminal device in the local area network 1, an implementation described in each step of step S21 to step S31 may also be used. Therefore, data exchange of the terminal device 1 and/or another terminal device in the local area network 1 can be implemented.

In this embodiment of this application, after the local area network 1 is created, the control plane network element may request, before requesting to allocate the dedicated multicast transmission path of the local area network 1, the multicast service management network element to allocate the dedicated uplink data tunnel of the local area network 1, and may send the correspondence between the identifier of the local area network 1 and the identifier of the uplink data tunnel 1 to the user plane network element, so that the user plane network element subsequently transmits the multicast data of the local area network 1 to the multicast service management network element by using the correspondence. This increases diversity of allocation manners of the dedicated uplink data tunnel of the local area network 1, and operations are more flexible.

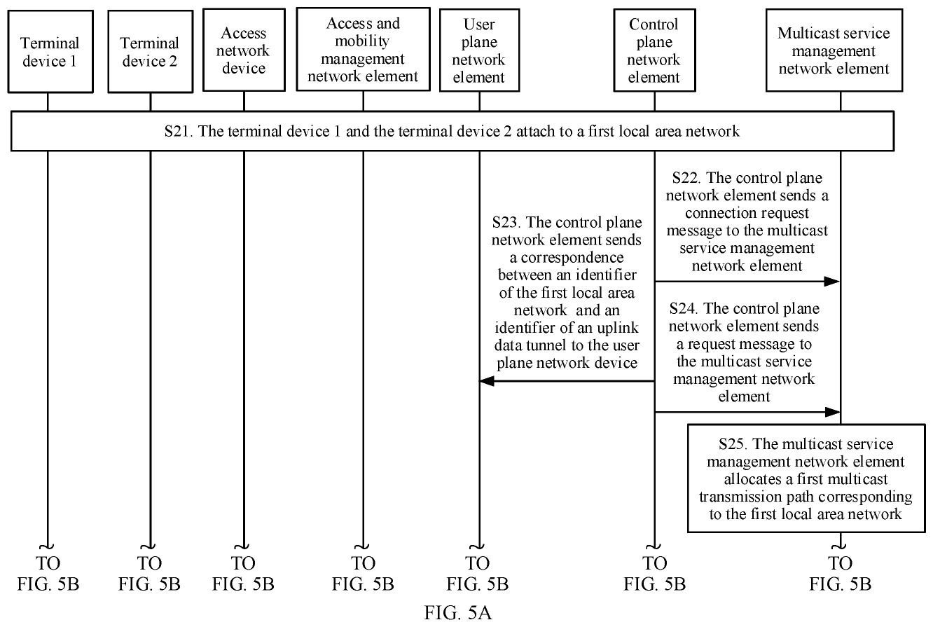

Optionally, it is assumed that in an application scenario, a cell to which a terminal device 1 attaches changes from an original cell 1 (or referred to as a first cell) to a cell 2 (or referred to as a second cell), an access network device connected to the terminal device 1 changes from an access network device 1 in the original cell 1 to an access network device 2 in the cell 2, and the cell 2 is not in a first serving cell set. In the foregoing application scenario, in this embodiment of this application, updating of information about a cell served by a dedicated multicast transmission path of a local area network 1 may be triggered, and the cell 2 is added to a cell set served by the dedicated multicast transmission path of the local area network 1, so that data transmission continuity of the terminal device 1 can be ensured, and data transmission reliability is enhanced. With reference to FIG. 6A and FIG. 6B, the following describes a service range updating manner of a dedicated multicast transmission path of the local area network 1 provided in this embodiment of this application.

FIG. 6A and FIG. 6B are another schematic flowchart of a data transmission method according to an embodiment of this application. In an implementation shown in FIG. 6A and FIG. 6B, for a terminal device 1, an access network device 1, an access and mobility management network element, a user plane network element, a control plane network element, and a multicast service management network element, refer to the implementations described in step S21 to step S31 in the foregoing embodiment in which operations such as allocating a dedicated multicast transmission path of a local area network 1 and broadcasting multicast data of the local area network 1. Details are not described herein again. Further, the data transmission method provided in this embodiment of this application may include the following steps.

S41. The terminal device 1 is handed over from an attached cell and triggers a tracking area update, and the access and mobility management network element obtains new location information of the terminal device 1.

In a feasible implementation, when the terminal device 1 is in a mobile state, for example, in a running vehicle, the terminal device 1 may be handed over from, as a location change before and after moving, the attached cell in a moving process. For example, the terminal device 1 is located in a cell 1 before moving, and an access network device connected to the terminal device 1 in the cell 1 may be the access network device 1. When the terminal device 1 moves to a cell 2, the terminal device 1 may be handed over from the access network device 1 in the cell 1 to an access network device 2 in the cell 2. After moving from the cell 1 to the cell 2, the terminal device 1 may trigger a handover process, and perform a tracking area update. After the tracking area update, the access and mobility management network element may obtain new location information of the terminal device 1, for example, information about the cell 2 in which the terminal device 1 is located.

S42. The access and mobility management network element forwards the location information of the terminal device 1 to the control plane network element.

In a feasible implementation, the access and mobility management network element may obtain the new location information of the terminal device 1, and may send the location information of the terminal device 1 to the control plane network element. For example, the location information may be information about an access network device (the access network device 2) connected to the terminal device 1, or an identifier of a cell (the cell 2) to which the terminal device 1 attaches. The control plane network element may determine a new cell set (which may be referred to as a second serving cell set) based on the new location information of the terminal device 1. The second serving cell set includes the cell 2 to which the terminal device 1 moves. The control plane network element may determine that a cell included in the second serving cell set is a cell covered by the local area network 1, and may update information about the local area network 1. Updated information about the local area network 1 includes information about the cell covered by the local area network 1, and the information about the cell covered by the local area network 1 includes the information about the cell 2. For example, the control plane network element may determine, based on the new location information of the terminal device 1, to add the cell 2 to which the terminal device 1 attaches to a first serving cell set, to update a cell set covered by the local area network 1 to obtain the second serving cell set. The second serving cell set includes the new cell in which the terminal device is located, namely, the cell 2. The second serving cell set may also include the cell 1 in which the terminal device 1 is located before moving. This is not limited herein.

Optionally, after the terminal device 1 is handed over from the cell 1 to the cell 2, if no terminal device belonging to the local area network 1 exists in the cell 1, the cell 1 may be removed from the first serving cell set, and the cell 2 is added to the first serving cell set, to generate a new serving cell set (the second serving cell set) of the local area network 1. This is not limited herein. Therefore, resource utilization of the dedicated multicast transmission path of the local area network 1 can be improved.

S43. The control plane network element sends an update request to the multicast service management network element, to trigger an information update process of a cell covered by the multicast transmission path corresponding to the first local area network.

Optionally, the control plane network element may send the update request to the multicast service management network element, and the update request includes information about the cell 1 and the information about the local area network 1. The information about the local area network 1 includes information about a cell covered by the local area network 1 before the terminal device 1 moves. The update request is used to trigger the multicast service management network element to update information about a cell covered by the dedicated multicast transmission path 1 of the local area network 1. An updated cell covered by the dedicated multicast transmission path 1 of the local area network 1 includes the cell 2, and the updated dedicated multicast transmission path 1 of the local area network 1 may be used to broadcast multicast data of the local area network 1 to access network devices in the cells (including the cell 2 in which the terminal device 1 is located) included in the second serving cell set.

S44. Update the information about the cell covered by the first multicast transmission path corresponding to the first local area network.

Optionally, the multicast service management network element may initiate, based on information such as information about the second serving cell set and an identifier of the local area network 1 sent by the control plane network element, an information update process of the cell covered by the dedicated multicast transmission path of the local area network 1, to update a cell range served by the dedicated multicast transmission path 1 of the local area network 1. In a specific implementation, for an implementation of the information update process of the cell covered by the dedicated multicast transmission path 1 of the local area network 1, refer to an implementation of an MBMS bearer update process in an eMBMS data transmission system. This is not limited herein.

After the information about the cell covered by the dedicated multicast transmission path 1 of the local area network 1 is updated, the control plane network element may send a correspondence between the identifier of the local area network 1 and an identifier of a multicast transmission path 2 to access network devices (including the access network device 2 to which the terminal device 1 attaches) in the cell 2 in which the terminal device is located. The access network device 2 may receive the multicast data of the local area network 1, and broadcast the multicast data to the terminal device 1 through the multicast transmission path 2. The terminal device 1 may receive the multicast data of the local area network 1 from the access network device 2. Terminal devices in other cells included in the second serving cell set may separately obtain the multicast data of the local area network 1 by using access network devices connected to the terminal devices.

S45. After receiving the multicast data of the first local area network, the multicast service management network element broadcasts the multicast data of the first local area network to the access network device in the second cell through the first multicast transmission path.

Optionally, after the terminal device 1 moves, the terminal device 1 may transmit data to the multicast service management network element by using the access network device 2 and the user plane network element, and broadcast, by using the multicast service management network element, the data to another access network device in a cell included in the second serving cell set on the multicast transmission path 1, to broadcast the data to another terminal device by using the another access network device.

Optionally, the multicast service management network element may broadcast multicast data of another terminal device in the local area network 1 to the access network device 2 by using the updated dedicated multicast transmission path 1 of the local area network 1, and broadcast the multicast data to the terminal device 1 by using the access network device 2. Therefore, continuity of receiving the multicast data of the local area network 1 by the terminal device 1 is ensured, data transmission reliability of the dedicated multicast transmission path of the local area network 1 is improved, and applicability is higher. Optionally, the multicast service management network element may broadcast data to another access network device in another cell included in the second serving cell set by using the updated dedicated multicast transmission path 1 of the local area network 1, and transmit the data to another terminal device by using the another access network device.

In this embodiment of this application, after the terminal device in the local area network 1 moves, a cell range (a service range of the dedicated multicast transmission path of the local area network 1) covered by the dedicated multicast transmission path of the local area network is updated based on information about a cell to which the terminal device moves, and the service range of the dedicated multicast transmission path of the local area network 1 is extended to the new cell in which the terminal device is located, so that resource utilization of multicast data transmission is improved, continuity of obtaining the multicast data of the local area network 1 by the terminal device in the local area network 1 is ensured, data transmission reliability of the dedicated multicast transmission path of the local area network 1 is improved, and applicability is higher.

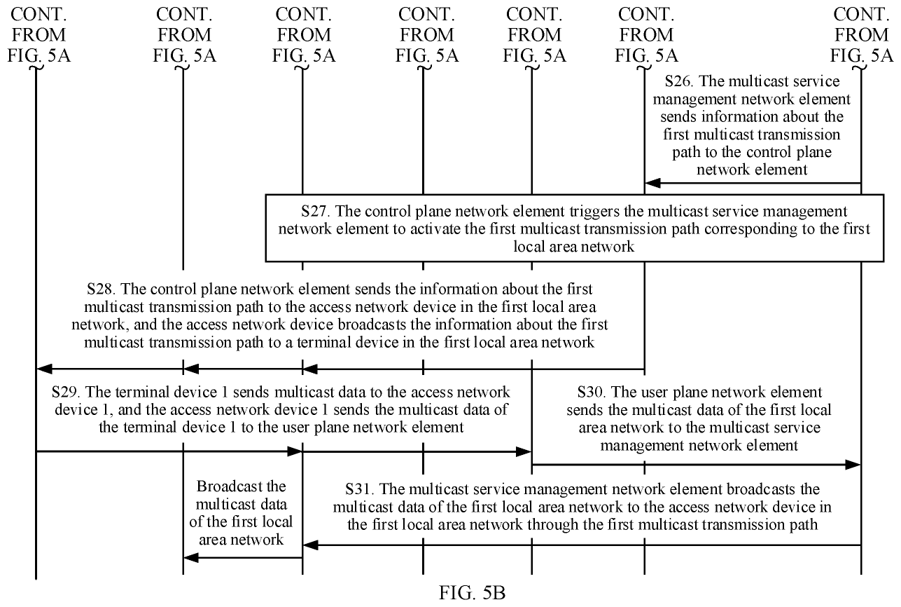

FIG. 7 is a schematic structural diagram of a multicast service management network element according to an embodiment of this application. The multicast service management network element provided in this embodiment of this application includes:

a receiving unit 71, configured to receive a request message from a control plane network element, where the request message carries information about a first local area network;

a processing unit 72, configured to allocate a first multicast transmission path corresponding to the first local area network when the receiving unit receives the request message, where the first multicast transmission path is used to broadcast multicast data of the first local area network; and

a sending unit 73, configured to send, to the control plane network element, information about the first multicast transmission path allocated by the processing unit 72.

The receiving unit 71 is further configured to receive first multicast data from a user plane network element.

The processing unit 72 is further configured to determine that the first multicast data received by the receiving unit is the multicast data of the first local area network.

The sending unit 73 is further configured to broadcast the first multicast data to an access network device in the first local area network through the first multicast transmission path, to broadcast the first multicast data to a terminal device in the first local area network by using the access network device.

In a feasible implementation, the receiving unit 71 is configured to receive the first multicast data from the user plane network element through an uplink data tunnel corresponding to the first local area network, and the processing unit 72 is configured to determine, based on an identifier of the uplink data tunnel through which the receiving unit receives the first multicast data, that the first multicast data is the multicast data of the first local area network.

In a feasible implementation, the information about the first local area network includes an identifier of the first local area network;

the processing unit 72 is further configured to allocate the uplink data tunnel corresponding to the first local area network; and

the sending unit 73 is further configured to send, to the control plane network element, the identifier of the uplink data tunnel corresponding to the first local area network that is allocated by the processing unit, where the uplink data tunnel is used to transmit the multicast data of the first local area network.

In a feasible implementation, the receiving unit 71 is further configured to receive a connection request message from the control plane network element, where the connection request message carries an identifier of the first local area network;

the processing unit 72 is further configured to allocate the uplink data tunnel corresponding to the first local area network when the receiving unit receives the connection request message; and the sending unit 73 is further configured to send, to the control plane network element, the identifier of the uplink data tunnel corresponding to the first local area network that is allocated by the processing unit, where the uplink data tunnel is used to transmit the multicast data of the first local area network.

In a feasible implementation, the information about the first local area network includes the identifier of the first local area network and information about a cell covered by the first local area network, and the cell covered by the first local area network includes a first cell in which a first terminal device sending the multicast data is located.

In a feasible implementation, the receiving unit 71 is further configured to receive an update request from the control plane network element, where the update request includes information about a second cell to which the first terminal device moves and the information about the first local area network;

the processing unit 72 is further configured to update, based on the information about the second cell and the information about the first local area network that are received by the receiving unit, information about a cell covered by the first multicast transmission path, where updated information about the cell covered by the first multicast transmission path includes the information about the second cell; and

the sending unit 73 is further configured to broadcast the multicast data of the first local area network to an access network device in the second cell through the first multicast transmission path updated by the processing unit.

In a specific implementation, the multicast service management network element may perform, by using the units included in the multicast service management network element, the implementations performed by the multicast service management network element in the foregoing embodiments. Details are not described herein again.

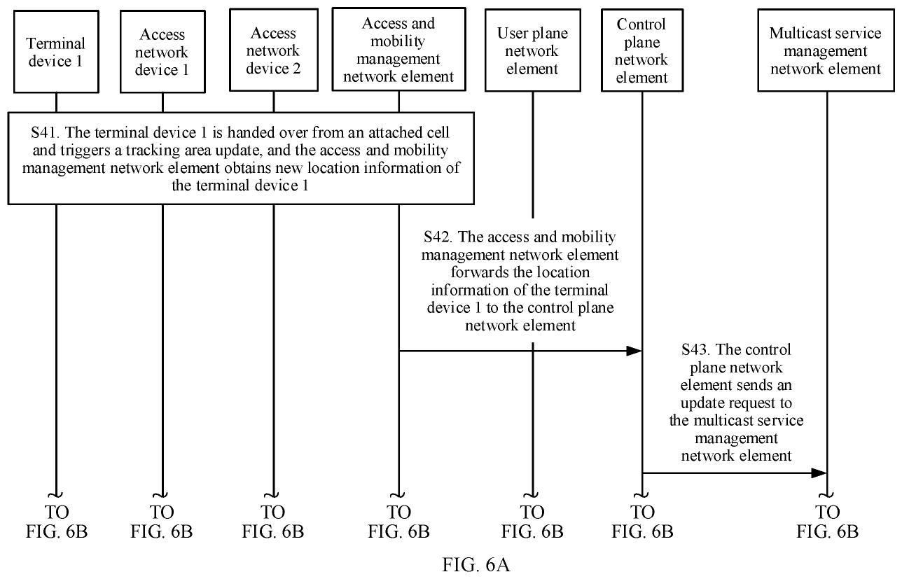

FIG. 8 is a schematic structural diagram of a control plane network element according to an embodiment of this application. The control plane network element provided in this embodiment of this application includes:

a sending unit 81, configured to send a request message to a multicast service management network element, where the request message carries information about a first local area network, and the request message is used to request to allocate a first multicast transmission path corresponding to the first local area network; and

a receiving unit 82, configured to receive information about the first multicast transmission path from the multicast service management network element.

The sending unit 81 is further configured to send the information about the first multicast transmission path received by the receiving unit to an access network device in the first local area network. The first multicast transmission path is used to broadcast multicast data of the first local area network to the access network device in the first local area network.

In a feasible implementation, the information about the first local area network includes an identifier of the first local area network and information about a cell covered by the first local area network, and the cell covered by the first local area network includes a first cell in which a first terminal device sending the multicast data is located.

In a feasible implementation, the receiving unit 82 is further configured to obtain information about a second cell to which the first terminal device moves; and the sending unit 81 is further configured to send an update request to the multicast service management network element, where the update request includes the information about the second cell that is received by the receiving unit and the information about the first local area network.

In a feasible implementation, the sending unit 81 is further configured to send a connection request message to the multicast service management network element, where the connection request message carries the identifier of the first local area network, the connection request message is used to request to allocate an uplink data tunnel corresponding to the first local area network, and the uplink data tunnel is an uplink data tunnel from a user plane network element to the multicast service management network element;

the receiving unit 82 is further configured to receive an identifier of the uplink data tunnel corresponding to the first local area network from the multicast service management network element; and

the sending unit 81 is further configured to send a correspondence between the identifier of the first local area network and the identifier of the uplink data tunnel to the user plane, where

the uplink data tunnel is used to transmit the multicast data of the first local area network from the user plane network element to the multicast service management network element.

In a specific implementation, the control plane network element may perform, by using the units included in the control plane network element, the implementations performed by the control plane network element in the foregoing embodiments. Details are not described herein again.

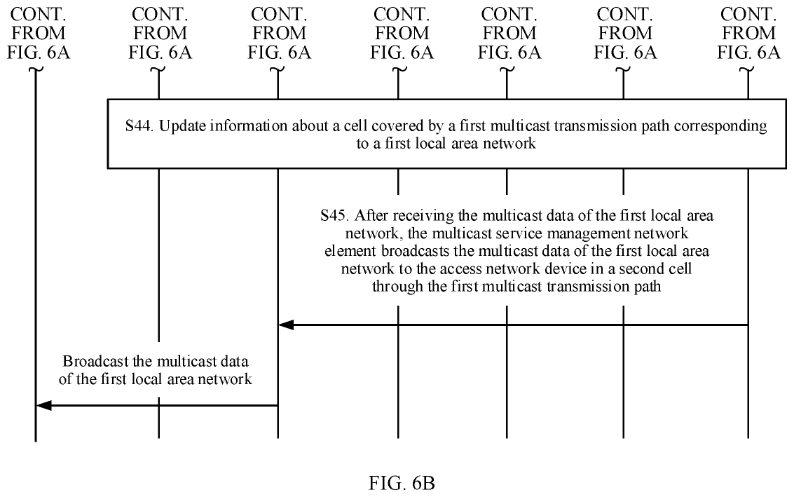

FIG. 9 is a schematic structural diagram of a user plane network element according to an embodiment of this application. The user plane network element provided in this embodiment of this application includes:

a receiving unit 91, configured to receive a correspondence between an identifier of a first local area network and an identifier of an uplink data tunnel from a control plane network element, where the uplink data tunnel is used to transmit multicast data of the first local area network to a multicast service management network element, and

the receiving unit 91 is further configured to receive first multicast data of the first local area network;

a processing unit 92, configured to determine, based on the correspondence received by the receiving unit, an uplink data tunnel corresponding to the first local area network; and

a sending unit 93, configured to send the first multicast data to the multicast service management network element through the uplink data tunnel that corresponds to the first local area network and that is determined by the processing unit.

In a specific implementation, the user plane network element may perform, by using the units included in the user plane network element, the implementations performed by the user plane network element in the foregoing embodiments. Details are not described herein again.

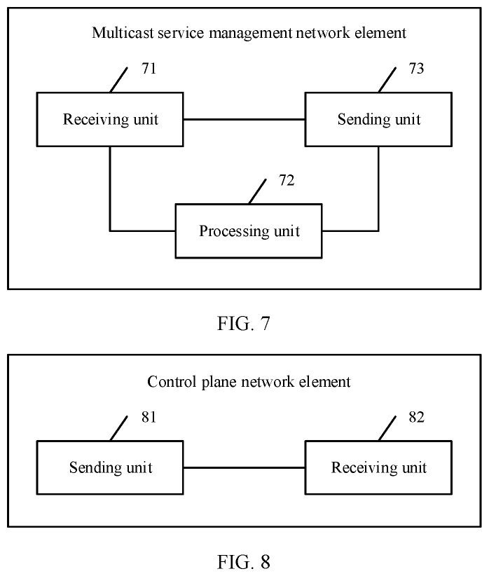

FIG. 10 is a schematic structural diagram of an access network device according to an embodiment of this application. The access network device provided in this embodiment of this application includes:

a receiving unit 11, configured to receive information about a first multicast transmission path from a control plane network element, where the first multicast transmission path is used to broadcast multicast data of a first local area network; and

a sending unit 12, configured to broadcast the information about the first multicast transmission path that is received by the receiving unit to a terminal device in the first local area network.

The receiving unit 11 is further configured to receive, through the first multicast transmission path, multicast data broadcast by a multicast service management network element.

The sending unit 12 is further configured to: when the receiving unit receives, through the first multicast transmission path, the multicast data broadcast by the multicast service management network element, broadcast the received multicast data to the terminal device in the first local area network.

In a specific implementation, the access network device may perform, by using the units included in the access network device, the implementations performed by the access network device in the foregoing embodiments. Details are not described herein again.

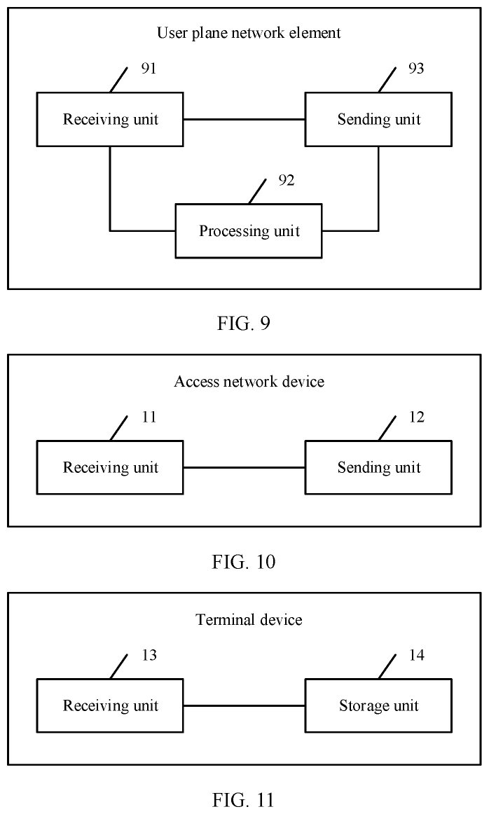

FIG. 11 is a schematic structural diagram of a terminal device according to an embodiment of this application. The terminal device provided in this embodiment of this application includes:

a receiving unit 13, configured to receive information about a first multicast transmission path from an access network device, where the first multicast transmission path is used to broadcast multicast data of a first local area network to which the terminal device belongs; and a storage unit 14, configured to store the information about the first multicast transmission path that is received by the receiving unit.

The receiving unit 13 is further configured to receive, through the first multicast transmission path, the multicast data of the first local area network broadcast by the access network device.

In a specific implementation, the terminal device may perform, by using the units included in the terminal device, the implementations performed by the terminal device in the foregoing embodiments. Details are not described herein again.

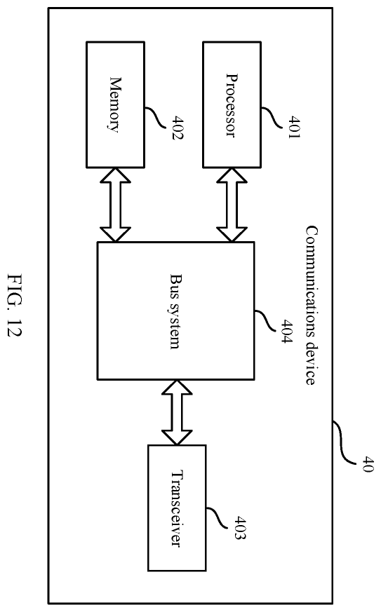

FIG. 12 is a schematic structural diagram of a communications device 40 according to an embodiment of this application. As shown in FIG. 12, the communications device 40 provided in this embodiment of this application includes a processor 401, a memory 402, a transceiver 403, and a bus system 404. The processor 401, the memory 402, and the transceiver 403 are connected by using the bus system 404.

The memory 402 is configured to store a program. The program may include program code, and the program code includes a computer operation instruction. The memory 402 includes but is not limited to a random access memory (RAM), a read-only memory (ROM), an erasable programmable read only memory (EPROM), or a compact disc read-only memory (CD-ROM). Only one memory is shown in FIG. 12. Certainly, a plurality of memories may be disposed according to a requirement. The memory 402 may alternatively be a memory in the processor 401. This is not limited herein.

The memory 402 stores the following elements: an executable module or a data structure, a subset of an executable module or a data structure, or an extended set of an executable module or a data structure.

an operation instruction: including various operation instructions, used to implement various operations; and

an operating system: including various system programs, used to implement various basic services and process a hardware-based task.

The processor 401 controls an operation of the communications device 40. The processor 401 may be one or more central processing units (CPU). When the processor 401 is one CPU, the CPU may be a single-core CPU, or may be a multi-core CPU.

During a specific application, components of the communications device 40 are coupled together by using the bus system 404. In addition to a data bus, the bus system 404 includes a power bus, a control bus, and a status signal bus. However, for clear description, various types of buses in FIG. 12 are marked as the bus system 404. For ease of illustration, FIG. 12 shows merely an example of the bus system 404.

The data transmission methods disclosed in the foregoing embodiments provided in the embodiments of this application may be applied to the processor 401, or may be implemented by the processor 401. The processor 401 may be an integrated circuit chip and has a signal processing capability. In an implementation process, steps in the foregoing methods can be implemented by using a hardware integrated logic circuit in the processor 401, or by using instructions in a form of software. The processor 401 may be a general purpose processor, a digital signal processor (DSP), an application-specific integrated circuit (ASIC), a field-programmable gate array (FPGA) or another programmable logic device, a discrete gate or transistor logic device, or a discrete hardware component. It may implement or perform the methods, the steps, and logical block diagrams that are disclosed in the embodiments of this application. The general purpose processor may be a microprocessor, or the processor may be any conventional processor or the like. Steps of the methods disclosed with reference to the embodiments of this application may be directly executed and accomplished by a hardware decoding processor, or may be executed and accomplished by using a combination of hardware and software modules in the decoding processor. A software module may be located in a mature storage medium in the art, such as a random access memory, a flash memory, a read-only memory, a programmable read-only memory, an electrically erasable programmable memory, a register, or the like. The storage medium is located in the memory 402. The processor 401 reads information in the memory 402, and performs the steps of the data transmission method described in the foregoing embodiments in combination with hardware of the processor 401.

A person of ordinary skill in the art may understand that all or some of the processes of the methods in the embodiments may be implemented by a computer program instructing related hardware. The program may be stored in a computer readable storage medium. When the program runs, the processes of the methods in the embodiments are performed. The foregoing storage medium includes any medium that can store program code, such as a ROM, a random access memory RAM, a magnetic disk, or an optical disk.

What is claimed is:

1. A data transmission method, comprising:
sending, by a control plane network element, a request message to a multicast service management network element, wherein the request message carries information about a first local area network;
receiving, by the multicast service management network element, the request message from the control plane network element;
allocating, by the multicast service management network element in response to the request message, a first multicast transmission path corresponding to the first local area network, wherein the first multicast transmission path is used to broadcast multicast data of the first local area network;
sending, by the multicast service management network element, information about the first multicast transmission path to the control plane network element;
receiving, by the control plane network element, the information about the first multicast transmission path from the multicast service management network element;
sending, by the control plane network element, the information about the first multicast transmission path to an access network device in the first local area network;
receiving, by the access network device, the information about the first multicast transmission path from the control plane network element;
broadcasting, by the access network device, the information about the first multicast transmission path to a terminal device in the first local area network;
receiving, by the multicast service management network element, first multicast data from a user plane network element, and determining that the first multicast data is the multicast data of the first local area network;
broadcasting, by the multicast service management network element, the first multicast data to the access network device in the first local area network through the first multicast transmission path; and
broadcasting, by the access network device, the received multicast data to the terminal device in the first local area network.

2. The method according to claim 1, wherein receiving the first multicast data and determining that the first multicast data is the multicast data of the first local area network comprises:
receiving, by the multicast service management network element, the first multicast data from the user plane network element through an uplink data tunnel corresponding to the first local area network; and
determining, by the multicast service management network element based on an identifier of the uplink data tunnel, that the first multicast data is the multicast data of the first local area network.

3. The method according to claim 2, wherein the information about the first local area network comprises an identifier of the first local area network, and the method further comprises:
allocating, by the multicast service management network element, the uplink data tunnel corresponding to the first local area network, and sending the identifier of the uplink data tunnel corresponding to the first local area network to the control plane network element, wherein
the uplink data tunnel is used to transmit the multicast data of the first local area network.

4. The method according to claim 2, further comprising:
receiving, by the multicast service management network element, a connection request message from the control plane network element, wherein the connection request message carries an identifier of the first local area network; and
allocating, by the multicast service management network element, the uplink data tunnel corresponding to the first local area network, and sending the identifier of the uplink data tunnel corresponding to the first local area network to the control plane network element, wherein
the uplink data tunnel is used to transmit the multicast data of the first local area network.

5. The method according to claim 4, wherein the information about the first local area network comprises the identifier of the first local area network and information about a cell covered by the first local area network, and the cell covered by the first local area network comprises a first cell in which a first terminal device sending the multicast data is located.

6. The method according to claim 5, further comprising:
receiving, by the multicast service management network element, an update request from the control plane network element, wherein the update request comprises information about a second cell to which the first terminal device moves and the information about the first local area network;
updating, by the multicast service management network element based on the information about the second cell and the information about the first local area network, information about a cell covered by the first multicast transmission path, wherein updated information about the cell covered by the first multicast transmission path comprises the information about the second cell; and
broadcasting, by the multicast service management network element, the multicast data of the first local area network to an access network device in the second cell through the first multicast transmission path.

7. The method according to claim 5, further comprising:
obtaining, by the control plane network element, information about a second cell to which the first terminal device moves; and
sending, by the control plane network element, an update request to the multicast service management network element, wherein the update request comprises the information about the second cell and the information about the first local area network.

8. The method according to claim 1, further comprising:
sending, by the control plane network element, a connection request message to the multicast service management network element, wherein the connection request message carries the identifier of the first local area network, the connection request message is used to request to allocate an uplink data tunnel corresponding to the first local area network, and the uplink data tunnel is an uplink data tunnel from a user plane network element to the multicast service management network element; and
receiving, by the control plane network element, an identifier of the uplink data tunnel corresponding to the first local area network from the multicast service management network element, and sending a correspondence between the identifier of the first local area network and the identifier of the uplink data tunnel to the user plane network element, wherein
the uplink data tunnel is used to transmit the multicast data of the first local area network from the user plane network element to the multicast service management network element.

9. The method according to claim 1, further comprising:
receiving, by the user plane network element, a correspondence between the identifier of the first local area network and an identifier of an uplink data tunnel from the control plane network element, wherein the uplink data tunnel is used to transmit the multicast data of the first local area network to the multicast service management network element;
receiving, by the user plane network element, the first multicast data of the first local area network; and
determining, by the user plane network element based on the correspondence, an uplink data tunnel corresponding to the first local area network, and sending the first multicast data to the multicast service management network element through the uplink data tunnel corresponding to the first local area network.

10. A data transmission method, comprising:
receiving, by a terminal device, information about a first multicast transmission path from an access network device, wherein the first multicast transmission path is used to broadcast multicast data of a first local area network to which the terminal device belongs; and
receiving, by the terminal device through the first multicast transmission path, the multicast data of the first local area network broadcast by the access network device.

11. A terminal device, comprising:
an interface;
a processor; and
a non-transitory computer-readable storage medium having instructions stored thereon that, when executed by the processor, cause the terminal device to:
receive information about a first multicast transmission path from an access network device, wherein the first multicast transmission path is used to broadcast multicast data of a first local area network to which the terminal device belongs; and
receive, through the first multicast transmission path, the multicast data of the first local area network broadcast by the access network device.
